(19) United States
(12) Patent Application Publication
(10) Pub. No.: US 2006/0066008 A1
(43) Pub. Date: Mar. 30, 2006

(54) Method for production of an apparatus for detection of the movement of a movable component

(76) Inventor: Harry Skarpil, Schwalbach (DE)

Correspondence Address: Martin A. Farber, Suite 473, 866 United Nations Plaza, New York, NY, 10017, US

(21) Appl. No.: 11/065,430

(22) Filed: Feb. 24, 2005

(30) Foreign Application Priority Data
Mar. 5, 2004 (DE) 10 2004 010 904.4

(51) Int. Cl. B29C 70/72; B29C 70/88

(52) U.S. Cl. 264/272.11

(57) ABSTRACT

In a method for production of an apparatus for detection of the movement of a movable component, the apparatus has an inner part 1 with a housing 11 and with an external contour like a pillar. Conductor tracks 3 are arranged on the pillar and are fitted with electrical components 4 and a sensor element. Ends of the sensor element project out of the inner part 1, forming plug contacts 6. The inner part 1 is extrusion coated with a plastic housing 2 permitting plug contacts 6 to project into the interior of a plug holder 5 in the plastic housing 2.

The invention relates to a method for production of an apparatus for detection of the movement of a movable component, with the apparatus having an inner part and the inner part having a housing with an external contour like a pillar, in which conductor tracks are arranged which are fitted with electrical components and a sensor element and one of whose ends projects out of the inner part forming plug contacts, or with the inner part comprising conductor tracks which are fitted with electrical components and a sensor element and one of whose ends form plug contacts, and with the inner part being extrusion coated with a plastic housing, in such a way that the plug contacts project into the interior of a plug holder in the plastic housing.

In a method such as this, it is known for the area, which is opposite the plug contacts, of the inner part which is inserted into the injection mold to be fixed in the correct position by supporting cores, which are then moved away from the inner parts corresponding to the progress of the spraying process.

This requires a drive for the movement of the supporting cores which must not start until shortly before the plastic injection-molding compound reaches the supporting cores, but not after it, since, otherwise, the position of the inner part can be changed by the spraying pressure. In this case, it is necessary to take account of factors such as the melting temperature and the subsequent pressure. Furthermore, it is necessary to ensure that the inner part is reliably surrounded by the plastic injection-molding compound, in particular and in addition on its end area which is opposite the plug contacts, so that the plastic housing is sealed.

The object of the invention is thus to provide a method of the type mentioned initially, by means of which a sealed plastic housing can be produced in a simple manner while the inner part is positioned in the correct orientation.

According to the invention, this object is achieved in that in a first step, the inner part is inserted into an injection mold, with those ends of the conductor tracks which form the plug contacts being held in a core in order to produce the plug holder, and that area of the inner part which is opposite the plug contacts being surrounded by a sleeve which can be moved in the injection mold and whose circumferential external contour corresponds to the internal contour of the injection mold which is formed like a pillar in this area, in that the sleeve is guided such that it can move on a guide element which is coaxial with respect to the sleeve and extends as a continuation of the conductor tracks, with that end area of the inner part which is opposite the plug contacts being held by the sleeve and/or by the guide element in its nominal position in the injection mold, in that, in a second step, plastic injection-molding compound is fired into the area of the injection mold between the sleeve and the plug holder, with the sleeve being moved by the spraying pressure of the plastic injection-molding compound against an opposing force after the area of the injection mold between the sleeve and the plug holder has been filled, to such an extent that it no longer surrounds the inner part, and the holding connection of the inner part to the sleeve and/or to the guide element is released.

During the spraying process, the sleeve remains in its position in which it surrounds the inner part, until the plastic injection-molding compound reaches it. Until this point is reached, the proximity of the injection point to the injection mold results in the plastic injection-molding compound being distributed largely uniformly. From then on, the plastic injection-molding compound moves the sleeve against the opposing force, with the sleeve ensuring that the plastic injection-molding compound progresses uniformly in the injection mold.

The sleeve or the guide element at the same time holds that end of the inner part which is opposite the plug contacts in the correct orientation and position in the injection mold. On the plug-contact side, this is done by the core for production of the plug holder.

Once that end of the inner part which faces away from the plug contacts has been reached, the sleeve or the guide element releases the inner part, and the plastic injection-molding compound flows around this end, at the end, so that this results in a plastic housing which is closed to form a seal and whose inner part is encapsulated in the correct orientation and position.

Since the movement of the sleeve does not require a drive or a drive device for the drive, but is produced by the plastic injection-molding compound, the tools which are required for this purpose are simple and cost-effective.

One end face of the guide element may make contact with that end area which is opposite the plug contacts of the inner part which is inserted into the injection mold, and/or may hold this end area and may be moved by the spraying pressure of the plastic injection-molding compound against an opposing force to a distance from the inner part, so that the plastic injection-molding compound can flow together radially inwards on the end face of the inner part, and closes the plastic housing.

In order to position the inner part easily in the correct orientation and position, the sleeve may have an inner contour, which corresponds to the external contour of the inner part, and which surrounds the inner part on its area which is opposite the plug contacts.

If the inner part is provided on its end face which is opposite the plug contacts with a plastic melting rib which surrounds it in an annular shape and projects axially, then this is melted onto the end face of the inner part as the plastic injection-molding compound flows around it, thus sealing any leaks in the plastic housing in the area radially within the melting rib which surrounds it in an annular shape, with respect to the external contour area of the inner part, which is like a pillar, with such leaks possibly resulting there as the plastic injection-molding compound flows radially together.

The sleeve and/or the guide element are/is moved in a simple manner against the force of a spring.

In order to ensure that the plastic injection-molding compound does not close uniformly on the end face of the inner part until the sleeve has moved out of the area of the inner part, the sleeve may have a stop which, once the sleeve has been moved out of the area of the inner part, makes contact with an opposing stop on the guide element and, in the event of any further movement by a specific amount, also moves the guide element away from the inner part by a specific amount.

It is self-evident that the stop on the sleeve and the opposing stop on the guide element may be released in some other way, for example by the use of tools in the mold.

A plastic housing with a uniform end face is produced if, when the stop is in contact with the opposing stop, those end faces of the sleeve and guide element which face the plastic housing extend on a plane.

The sleeve may have a second stop which makes contact with a second opposing stop on the guide element before the movement of the sleeve out of the area of the inner part.

This determines the initial position of the sleeve, before the spraying process, in a simple manner.

It is self-evident that the second stop on the sleeve and the second opposing stop on the guide element may also be released in some other way, for example by the use of tools in the mold.

The plastic housing may at the same time and integrally be provided with an attachment flange when, in the area between the sleeve and the plug holder, the injection mold has cavitation for integral spraying of an attachment flange onto the plastic housing.

In this case, for strength reasons, a metal bush is preferably inserted into the cavitation before the plastic injection-molding compound is fired into the injection mold.

The device can be produced simply and robustly by forming the conductor tracks from a stamped sheet-metal part (leadframe), with the electrical components as well as the sensor element being welded or soldered to the conductor tracks.

The sensor element may be a Hall element which is arranged on that end area of the conductor tracks which is opposite the plug contacts.

In order to ensure that the plastic injection-molding compound flows uniformly, the sleeve and/or the guide element may be heated during the spraying process.

Exemplary embodiments will be described in more detail in the following text and are illustrated in the drawing, in which:

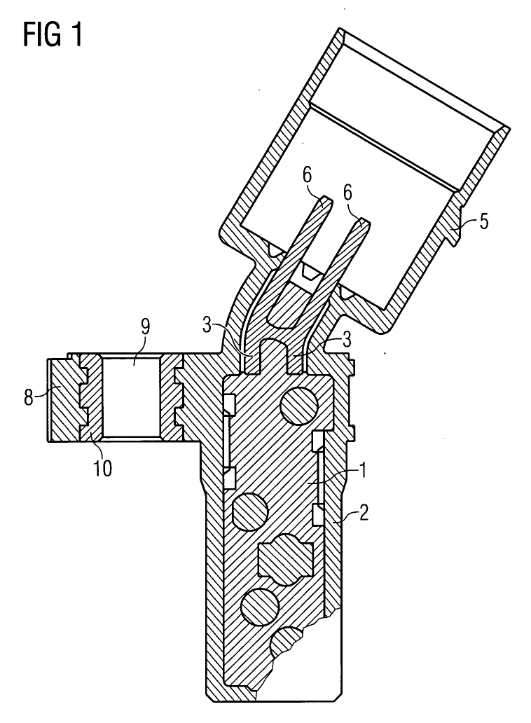

FIG. 1 shows a section view of a rotation speed sensor,

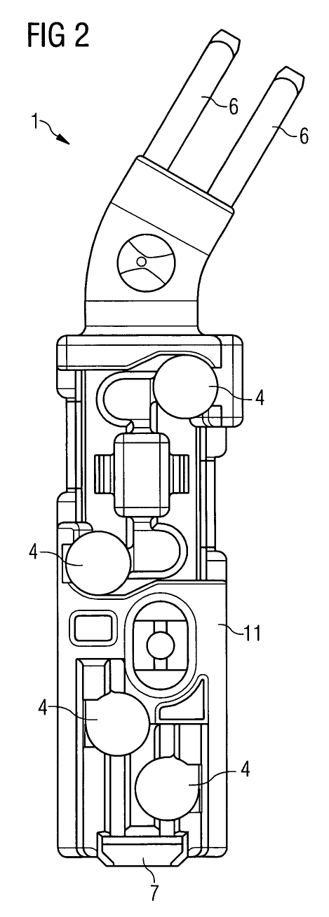

FIG. 2 shows a view of an inner part of the rotation speed sensor shown in FIG. 1,

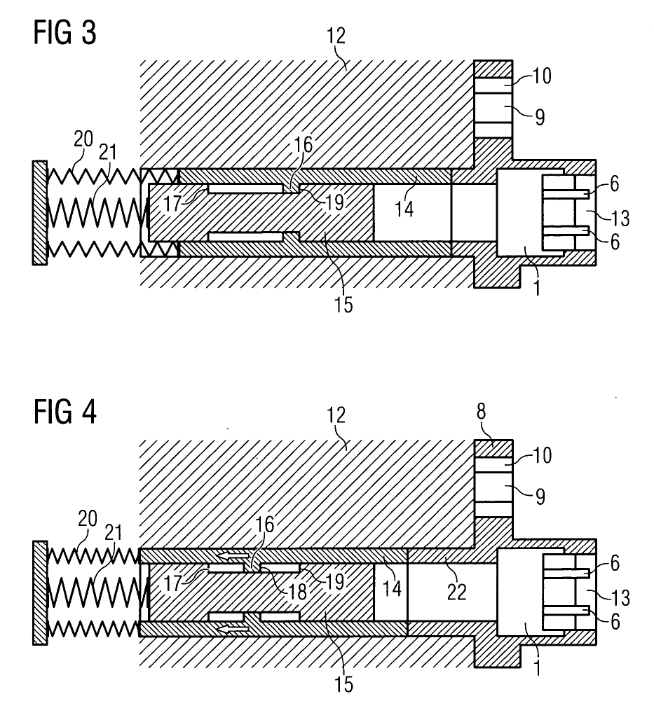

FIG. 3 shows a schematic illustration, in the form of a section, of a first exemplary embodiment of a device for production of a rotation speed sensor, in a first step,

FIG. 4 shows the device shown in FIG. 3, in a second step,

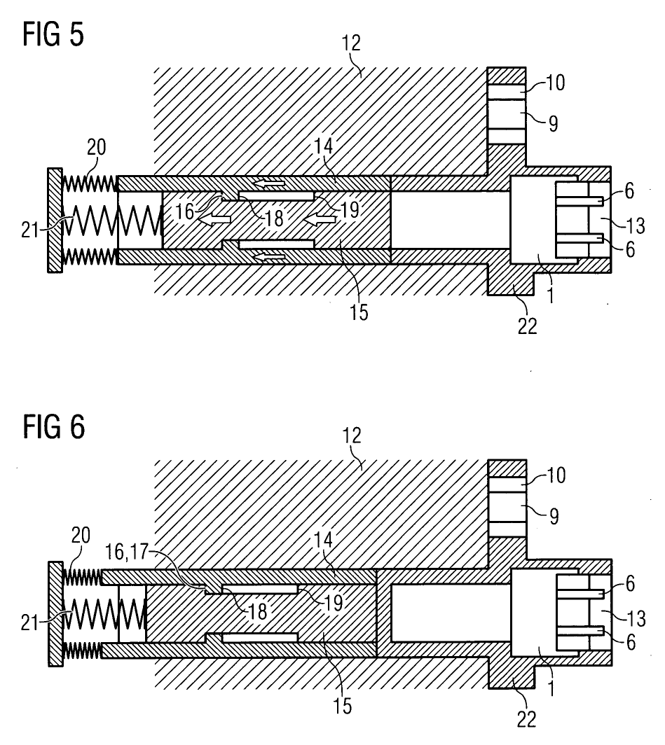

FIG. 5 shows the device shown in FIG. 3, in a third step,

FIG. 6 shows the device shown in FIG. 3, in a fourth step,

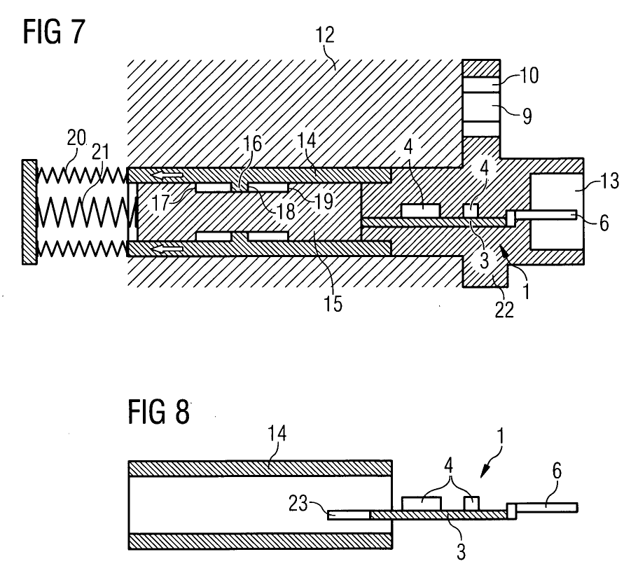

FIG. 7 shows a schematic illustration, in the form of a section, of a second exemplary embodiment of a device for production of a rotation speed sensor,

FIG. 8 shows the sleeve and the inner part for production of a rotation speed sensor by means of the device shown in FIG. 7.

The rotation speed sensor which is illustrated in FIG. 1 is used to detect the rotation speed of a magnetically coded wheel, which is not illustrated, by the production of appropriate pulses. The rotation speed sensor has an inner part 1, which is arranged in a plastic housing 2 by extrusion coating with a plastic injection-molding compound. The inner part has conductor tracks 3, which are in the form of a stamped sheet-metal part, on which electrical components 4 are arranged by welding.

One of the ends of the conductor tracks 3 projects into a plug holder 5 in the plastic housing 2, and forms plug contacts 6.

A Hall element 7 is likewise arranged by welding at those ends of the conductor tracks 3 which are opposite the plug contacts 6.

In an area close to the plug holder 5, the plastic housing 2 has an integrally sprayed-on attachment flange 8 with a sprayed-in metal bush 10, which has an attachment hole 9.

Large areas of the inner part 1 are extrusion coated with a plastic which forms a housing, with that area of the inner part 1 which is opposite the plug holder 5 having an external contour which is approximately in the form of a pillar.

In order to produce a rotation speed sensor such as this, as shown in FIG. 3, a corresponding inner part is inserted into an injection mold of a tool 12 in such a way that the plug contacts 6 project into a core 13 and are held there, with this being used to produce the plug holder 6.

That area of the inner part 1 which is opposite the plug contacts 6 projects into an area of the injection mold in which a sleeve 14 is arranged such that it can be moved and whose radially circumferential external contour corresponds to the inner contour of the injection mold, which is formed like a pillar in this area.

A guide element 15 which is guided such that it can move co-axially with respect to the sleeve 14 is arranged in the interior of the sleeve 14 and has a radially circumferential external contour which corresponds to the radially circumferential inner contour of the sleeve 14.

The sleeve has a stop 16 against which an opposing stop 17 on the guide element 15 can make contact. The sleeve 14 also has a second stop 18, against which a second opposing stop 19 on the guide element 15 can make contact.

These stops 16 and 18 as well as the opposing stops 17 and 19 allow the sleeve 14 and the guide element 15 to be moved through a specific amount relative to one another.

A first compressor spring 20, which is supported in a fixed manner at one end, acts on the sleeve 14, and a second compressor spring 21 which is supported in a fixed manner at one end, acts on the guide element 15, in the direction of insertion into the injection mold.

The inner part 1, which is inserted into the injection mold in FIG. 3, is first of all surrounded by the sleeve 14 in its pillar-like area and is held in its correct position in the injection mold. In this case, the sleeve 14 is pushed to its furthest position to the right by the first compression spring 20, with the second stop 18 making contact with the second opposing stop 18, and defining the position and orientation of the guide element 15.

If plastic injection-molding compound 22 is now fired into the injection mold, as shown in FIG. 4, in an area between the sleeve 14 and the plug holder 5, this compound is distributed in the available area in the injection mold until this area is filled (FIG. 4).

If more plastic injection-molding compound 22 is fired in, this leads to the right-hand end face of the sleeve 14 being acted on by the plastic injection-molding compound 22, whose spraying pressure moves the sleeve to the left against the force of the first compression spring 20. The plastic injection-molding compound 22 is also readjusted, corresponding to the movement of the sleeve 14 (FIG. 5).

When the sleeve 14 has been moved so far to the left that it no longer surrounds the inner part 1 and holds it in position, the stop 16 also makes contact with the opposing stop 17 and, when the sleeve 14 is moved further to the left by the plastic injection-molding compound 22, moves the guide element 15 against the force of the second compression spring 21 to the left, as well, until the final position illustrated in FIG. 6 is reached.

The plastic injection-molding compound 22 which has been fired into the injection mold by this time now holds the inner part 1 in a correct position.

Further movement of the sleeve 14 and of the guide element 15 to the left results in the formation of a gap between the end-face end of the inner part 1 and the end faces of the sleeve 14 and guide element 15, which are opposite on a plane, which gap is likewise filled by the plastic injection-molding compound 22, so that the plastic housing 2 is closed, and is complete.

In the exemplary embodiment shown in FIGS. 7 and 8, the inner part 1 comprises only the conductor tracks 3 and the electrical components as well as the Hall element 7, and does not have a housing 11. The conductor tracks 3 are held in the correct position in the injection mold by the end face of the guide element 15 and a slot guide 23 in the sleeve 14 for the conductor track ends.

Firing the plastic injection-molding compound 22 in a manner corresponding to the exemplary embodiment shown in FIGS. 3 and 6 results, in the same way, in the movement of the sleeve 14 by the plastic injection-molding compound 22 and in the movement of the guide element 15 via the stop 16 and the opposing stop 17 to its final position.

1-13. (canceled)

14. In a method for production of an apparatus for detection of the movement of a movable component, the apparatus having an inner part comprising a housing with an external contour in the form of a pillar; and wherein the apparatus includes conductor tracks that are fitted with electrical components and a sensor element, one of whose ends projects out of the inner part to form plug contacts, or one of whose ends form plug contacts;
wherein the method provides that the inner part is extrusion coated with a plastic housing to enable the plug contacts to project into the interior of a plug holder in the plastic housing;
in steps of the method, the inner part (1) is inserted into an injection mold, with those ends of the conductor tracks (3) which form the plug contacts (6) being held in a core (13) in order to produce the plug holder (5);
an area of the inner part (1) which is opposite the plug contacts (6) is surrounded by a sleeve (14) which can be moved in the injection mold and whose circumferential external contour corresponds to an internal contour of the injection mold that is formed like a pillar in this area;
wherein the apparatus has a guide element (15), and the sleeve (14) is guided for movement on the guide element (15), the guide element being coaxial with respect to the sleeve (14) and extending as a continuation of the conductor tracks (3); and wherein the end area of the inner part (1), which is opposite the plug contacts (6), is held by the sleeve (14) and/or by the guide element (15) in a nominal position in the injection mold;
wherein, in further steps of the method, a plastic injection-molding compound (22) is fired into an area of the injection mold between the sleeve (14) and the plug holder (5); and
the sleeve (14) is moved by a spraying pressure of a plastic injection-molding compound (22) against an opposing force after the area of the injection mold between the sleeve (14) and the plug holder (5) has been filled, the movement of the sleeve providing that the sleeve no longer surrounds the inner part (1), and that a holding connection of the inner part (1) to the sleeve (14) and/or to the guide element (15) is released.

15. The method as claimed in claim 14, wherein the guide element (15) is in contact with an end face on the end area, which is opposite the plug contacts (6), of the inner part (1) which is inserted into the injection mold, and/or holds this end area and is moved by the spraying pressure of the plastic injection-molding compound (22) against an opposing force to a distance from the inner part (1).

16. The method as claimed in claim 14, wherein the sleeve (14) has an inner contour, which corresponds to the external contour of the inner part (1) and surrounds the inner part (1) on its area which is opposite the plug contacts (6).

17. The method as claimed in claim 14, wherein the inner part (1) is provided on its end face, which is opposite the plug contacts (6), with a plastic melting rib which surrounds it in an annular shape and projects axially.

18. The method as claimed in claim 14, wherein the sleeve (14) and/or the guide element (15) are/is moved against the force of a spring (20, 21).

19. The method as claimed in claim 14, wherein the sleeve (14) has a stop (16) which, once the sleeve (14) has been moved out of the area of the inner part (1), makes contact with an opposing stop (17) on the guide element (15) and, in the event of a further movement by a predetermined amount, also moves the guide element (15) away from the inner part (1) by the predetermined amount.

20. The method as claimed in claim 19 wherein, when the stop (16) makes contact with the opposing stop (17), those end faces of the sleeve (14) and guide element (15) which face the plastic housing (2) extend on a plane.

21. The method as claimed in claim 14, wherein the sleeve (14) has a second stop (18), which makes contact with a second opposing stop (19) on the guide element (15) before movement of the sleeve (14) out of the area of the inner part (1).

22. The method as claimed in claim 14, wherein in the area between the sleeve (14) and the plug holder (5), the injection mold has a cavitation for integral spraying of an attachment flange (8) onto the plastic housing (2).

23. The method as claimed in claim 22, wherein a metal bush (10) is inserted into the cavitation before the plastic injection-molding compound (22) is fired into the injection mold.

24. The method as claimed in claim 14, wherein the conductor tracks (3) are formed by a stamped sheet-metal part (leadframe), and the electrical components (4) as well as the sensor element are welded or soldered to the conductor tracks (3).

25. The method as claimed in claim 14, wherein the sensor element is a Hall element (7), and is arranged on an end area of the conductor tracks (3) which is opposite the plug contacts (6).

26. The method as claimed in claim 14, wherein the sleeve and/or the guide element are/is heated during the spraying process.
